(19) United States
(12) Patent Application Publication
(10) Pub. No.: US 2026/0021441 A1
(43) Pub. Date: Jan. 22, 2026

(54) CAPTURE VESSEL FOR CARBON CAPTURE SYSTEM

(71) Applicant: Enhanced Energy Group LLC, West Kingston, RI (US)

(72) Inventors: Barry Drake LAWSON, Houston, TX (US); Paul M. DUNN, West Kingston, RI (US); Garett Paul LAMBERT, Houston, TX (US); Behnam FAKHARI KISOMI, Houston, TX (US); Doru Catalin DOSIANU, Hockley, TX (US)

(73) Assignee: Enhanced Energy Group LLC, West Kingston, RI (US)

(21) Appl. No.: 18/774,357

(22) Filed: Jul. 16, 2024

(51) Int. Cl. B01D 53/04

(52) U.S. Cl. CPC B01D 53/0462; B01D 53/0438; B01D 2257/504; B01D 2257/80; B01D 2258/0283

(57) ABSTRACT

A capture vessel includes an ingress flow channel coupled to an inlet flange to receive a first gas; an egress flow channel coupled to an outlet flange to provide at least a portion of a second gas to the outlet flange; one or more radial flow channels that extend radially between the ingress flow channel and the egress flow channel; and capture media arranged in the one or more radial flow channels and configured to convert at least a portion of the first gas into the portion of the second gas. The one or more radial flow channels are configured to receive the portion of the first gas from the ingress flow channel, such that the portion of the first gas interacts with the capture media to produce the portion of the second gas, and provide the portion of the second gas to the egress flow channel.

### TECHNICAL FIELD

The present disclosure relates generally to carbon capture and thermal swing adsorption (TSA) processes for carbon capture.

### BACKGROUND

Molecular (mole) sieves include synthetic media (e.g., ceramic-like media), available in various physical sizes (powder to ¼ inch round). Based on a composition and crystal structure of the synthetic media, mole sieves are capable of adsorbing, or not adsorbing, particular species of molecule based mostly on a size of the molecule. For example, a 3 A sieve will adsorb water (H₂O), ammonia (NH₃), and little else. Molecules like CO₂, O₂, N₂, and argon would pass through the 3 A sieve. The 3 A sieve (and alumina) are typically used in dehydration processes. A 5 A sieve will adsorb all of the species of the 3 A, but will also adsorb CO₂ and most pollutants (CO, HC, NOx) while allowing O₂, N₂, and argon to pass through the 5 A sieve. A 13× sieve captures larger molecules, including many hydrocarbons, but still allows O₂ and argon to pass through the 13× sieve. When a mole sieve is cold and a partial pressure of a desired species is high, the mole sieve will adsorb the desired species. The mole sieve will release the desired species when a temperature is increased and/or the partial pressure is lowered. Hence, the terms pressure swing, thermal swing, vacuum swing, or combinations of the swing processes are used to describe the capture and release of the desired species by the mole sieve. A viability and economics of carbon capture technologies are significantly impacted by an energy consumption of the CO₂ capture processes. However, the swing processes are inefficient in terms of electrical power required to perform the swing processes to sufficiently capture and release CO₂, which increases costs.

Activated carbon behaves similarly to mole sieves, and can be used in lieu of mole sieves in some cases. However, activated carbon has a different affinity for compounds that is not based on molecule size. Using activated carbon is higher in cost and lower in performance in terms of CO₂ capture as compared with mole sieves, but has advantages of a lower heat of adsorption for water (e.g., about 1000 BTU/lb for activated carbon vs. about 1800 BTU/lb for mole sieves) and a lower heat of adsorption for CO₂.

The carbon capture system of the present disclosure solves one or more of the problems set forth above and/or other problems in the field.

### SUMMARY

A capture vessel may include an outer vessel wall that defines an interior volume of the capture vessel; an inlet flange arranged at the outer vessel wall and configured to receive a first gas and provide the first gas to the interior volume; an outlet flange arranged at the outer vessel wall and configured to receive a second gas from the interior volume and output the second gas from the capture vessel; an ingress flow channel coupled to the inlet flange to receive the first gas, wherein the ingress flow channel extends, partially through the interior volume, parallel to an axial axis of the capture vessel; a first egress flow channel coupled to the outlet flange to provide at least a first portion of the second gas to the outlet flange, wherein the first egress flow channel extends, partially through the interior volume, parallel to the axial axis of the capture vessel; one or more first radial flow channels that extend radially between the ingress flow channel and the first egress flow channel; and first capture media arranged in the one or more first radial flow channels and configured to convert at least a first portion of the first gas into the first portion of the second gas, wherein the one or more first radial flow channels are configured to receive the first portion of the first gas from the ingress flow channel, such that the first portion of the first gas interacts with the first capture media to produce the first portion of the second gas, and provide the first portion of the second gas to the first egress flow channel.

A capture vessel may include an outer vessel wall that defines an interior volume of the capture vessel; an inlet flange arranged at the outer vessel wall and configured to receive a first gas and provide the first gas to the interior volume; an outlet flange arranged at the outer vessel wall and configured to receive a second gas from the interior volume and output the second gas from the capture vessel; capture media arranged within the interior volume of the capture vessel and to convert the first gas into the second gas by adsorption of one or more adsorbates; and one or more coils distributed within the interior volume and thermally coupled to the capture media, wherein the one or more coils are configured to carry one or more thermal fluids for regulating a temperature of the capture media, and wherein the one or more thermal fluids include a heating fluid configured to increase the temperature of the capture media during a regeneration stage of the capture media, and a cooling fluid configured to decrease the temperature of the capture media during at least one of an adsorption stage of the capture media or a cooling stage of the capture media.

### BRIEF DESCRIPTION OF THE DRAWINGS

FIG. 1A illustrates a first portion of a carbon capture system according to one or more implementations.

FIG. 1B illustrates a second portion of the carbon capture system shown in FIG. 1A.

FIG. 2A illustrates an axial cross-section of a capture vessel according to one or more implementations.

FIG. 2B illustrates a radial cross-section of the capture vessel shown in FIG. 2A.

FIG. 3 illustrates an axial cross-section of a capture vessel according to one or more implementations.

FIG. 4 illustrates an axial cross-section of a capture vessel according to one or more implementations.

FIG. 5 illustrates an axial cross-section of a capture vessel according to one or more implementations.

FIG. 6 illustrates an axial cross-section of a capture vessel according to one or more implementations.

FIG. 7A illustrates an axial cross-section of a capture vessel according to one or more implementations.

FIG. 7B illustrates a radial cross-section of the capture vessel shown in FIG. 7A.

FIG. 8 illustrates an axial cross-section of a capture vessel according to one or more implementations.

FIG. 9A illustrates an axial cross-section of a capture vessel according to one or more implementations.

FIG. 9B illustrates a perspective view of the capture vessel shown in FIG. 9A.

FIG. 10A illustrates a side view of a capture vessel according to one or more implementations.

FIG. 10B illustrates a cross-section of the capture vessel shown in FIG. 10A.

FIG. 11 illustrates an axial cross-section of a capture vessel according to one or more implementations.

### DETAILED DESCRIPTION

This disclosure relates to carbon capture, which is applicable to any machine, system, or plant that uses a combustion engine, such as a piston engine or a turbine engine. For example, the disclosure relates to a CO₂ thermal swing adsorption (TSA) process with improved performance using enhanced capture vessel geometries. Advanced capture vessel designs disclosed herein may improve capture performance via enhanced utilization of a capture media and may reduce parasitic electrical loads of a carbon capture system through improved hydraulic performance requirements of the capture vessel. In some implementations, a capture vessel geometry may decrease a vessel pressure drop and increase a utilization of the capture media. An energy cost associated with CO₂ capture can be significantly reduced by utilizing the advanced capture vessel designs described herein, which may significantly reduce the carbon capture system's pressure drop requirements and may increase the utilization of the capture media.

Some implementations provide design features for capture vessels to improve a capture performance and significantly reduce a parasitic electrical load of the carbon capture system associated with vessel hydraulic requirements. These design features include, but are not limited to: alternative vessel geometries and internal designs for improved hydraulic performance and/or internal coils for controlling or otherwise regulating capture bed temperature using a heat transfer fluid for vessel cooling, vessel heating, or both vessel cooling and vessel heating, depending on a process stage.

The carbon capture systems and methods may provide as least one of the following benefits, including: (1) lower the cost of carbon capture in small distributed applications, generally between 1 and 40 MW per engine, targeting CO₂ associated with semi-closed cycle techniques (e.g., a process that uses a combination of cooled exhaust recirculation and oxygen augmentation for reciprocating piston engines and/or gas turbine engines), but also applicable to other sources; (2) enable a use of high performance molecular sieves, in a TSA process, in a manner which does not dilute a purity of or reduce a capture efficiency of the CO₂; (3) substantially reduce electrical and/or mechanical loads associated with the carbon capture; (4) improve a construction of TSA vessels to lower the cost of carbon capture and to minimize performance issues associated with pressure drop and/or leakage; (5) mitigate other pollutants, such as NOx, SOx, CO, and HC; and (6) provide a solution suitable for new construction or retrofit application at lower cost.

The carbon capture systems and methods target dilute CO₂ streams (3-11% CO₂ content) that exist in distributed power to gas turbines, lean burn piston engines (spark or compression ignited), and rich burn piston engines, with or without exhaust concentration of the SCC. The carbon capture systems and methods may improve regeneration performance in CO₂-TSA, reducing a time for regeneration and improving a percentage of carbon captured.

Some implementations may provide a system for a CO₂-TSA process or a dehydration process with a minimum of three steps including adsorption (e.g., a capture stage), regeneration (e.g., a regeneration stage), and cooling (e.g., a cooling stage). For example, a CO₂-TSA process may include a cyclical sequence including at least a CO₂ capture stage, a regeneration stage, and a cooling stage. A capture vessel may include capture media arranged inside the capture vessel configured to adsorb CO₂ from an exhaust gas during the CO₂ capture stage to produce a depleted flue gas, substantially depleted of CO₂, that exits the capture vessel. Additionally, or alternatively, a capture vessel may include capture media arranged inside the capture vessel configured to adsorb water molecules from an exhaust gas (e.g., from a wet gas) during the CO₂ capture stage to produce a dry gas that is substantially depleted of water molecules. Thus, a capture vessel may capture one or more adsorbates (e.g., CO₂, water molecules, or another component). The capture media for adsorbing CO₂ may be different from the capture media for adsorbing water molecules.

Some implementations may provide one or more single-flow cylindrical capture vessels to decrease a vessel pressure drop.

Some implementations may provide one or more double-flow cylindrical capture vessels to decrease the vessel pressure drop.

Some implementations may provide a capture vessel configured to reduce one or more hydraulic requirements required by the capture vessel for eliminating one or more draft fans from the carbon capture system and/or to reduce a size of one or more draft fans from the carbon capture system.

Some implementations may provide a capture vessel that includes distributed coils to cool the capture media and aid in the adsorption stage.

Some implementations may provide a capture vessel that includes distributed coils to cool the capture media and aid in the cooling stage.

In some implementations, a thermal fluid within the distributed coils may be water, a thermal oil, or chilled fluid/refrigerant.

Some implementations may provide a capture vessel that includes distributed coils to heat the capture media and aid in the regeneration stage.

In some implementations, a thermal fluid may be used within the distributed coils for heating. The thermal fluid may be a thermal oil or (hot) CO₂.

In some implementations, a portion of engine exhaust, either from a main exhaust source or an auxiliary exhaust source, may be used within the distributed coils as a thermal fluid for heating.

Some implementations may provide a capture vessel with a single-flow box design to decrease a pressure drop and decrease fabrication and maintenance complexity.

Some implementations may provide a capture vessel with a double-flow box design to decrease a pressure drop and decrease fabrication and maintenance complexity.

Some implementations may provide a capture vessel with a horizontal flow direction for a cylindrical design.

Some implementations may provide a capture vessel with a vertical flow direction for a cylindrical design.

Some implementations may provide a capture vessel with a horizontal flow direction for a box design.

Some implementations may provide a capture vessel with a vertical flow direction for a box design.

Temperature relative terms, such as “warm,” “hot,” “hotter,” “cold,” “colder,” “cool,” “cooler,” and the like, may be used herein for ease of description to describe one element or feature's relationship to another element(s) or feature(s) and are meant to be relative to each other and not restricted to any specific range of absolute temperature unless specifically defined. Even if specifically defined, absolute temperatures or temperature ranges are intended to serve as examples.

In some implementations, “dry,” “lean,” “wet,” and “rich” may be used herein for ease of description to describe one element or feature's relationship to another element(s) or feature(s) and are meant to be relative to each other and not restricted to any specific range of percent by volume. For example, “dry” may correspond to a gas or fluid that contains less water content than a wet gas or a wet fluid. Similarly, “lean” may correspond to a gas or fluid that contains less water content than a rich gas or a rich fluid. For example, in some implementations, a dry gas or a dry fluid may contain 50% less water than a corresponding wet gas or a corresponding wet fluid, respectively. In some implementations, a dry gas or a dry fluid may contain 75% less water than a corresponding wet gas or a corresponding wet fluid, respectively. In some implementations, a dry gas or a dry fluid may contain 90% less water than a corresponding wet gas or a corresponding wet fluid, respectively. In some implementations, a lean gas or a lean fluid may contain 50% less water than a corresponding rich gas or a corresponding rich fluid, respectively. In some implementations, a lean gas or a lean fluid may contain 75% less water than a corresponding rich gas or a corresponding rich fluid, respectively. In some implementations, a lean gas or a lean fluid may contain 90% less water than a corresponding rich gas or a corresponding rich fluid, respectively.

In some implementations, “dry” and “lean” may mean substantially free of water or water molecules. “Substantially free” may mean less than 1% by volume. Thus, “substantially free of water molecules” may refer to a fluid or a fluid mixture that is composed of less than 1% of water molecules by volume. In addition, “wet” or “rich” may mean saturated with or at least partially saturated with water or water molecules. For example, a fluid that is wet or rich may be composed of at least 1% of water molecules by volume.

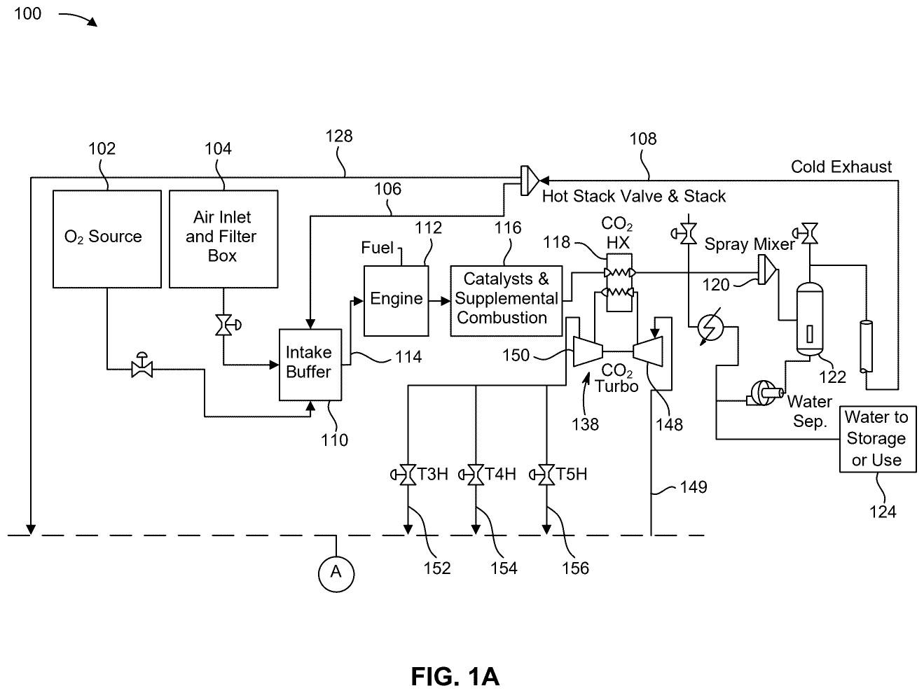

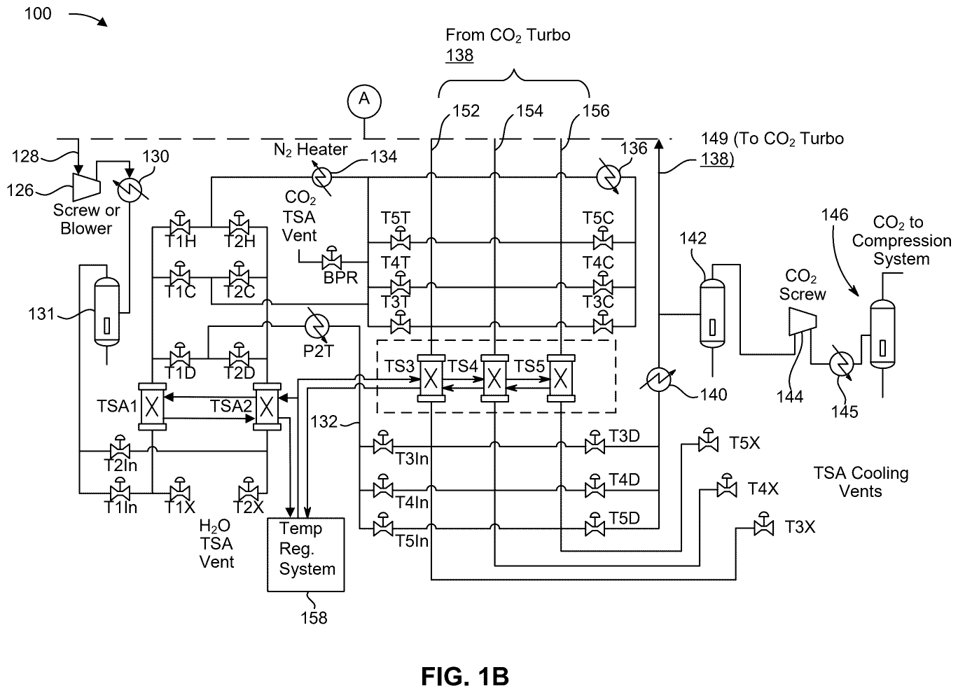

FIG. 1A illustrates a first portion of a carbon capture system 100 according to one or more implementations. FIG. 1B illustrates a second portion of the carbon capture system 100 shown in FIG. 1A. The first portion and the second portion are joined at dotted line A, such that certain manifolds extend across both FIGS. 1A and 1B.

The carbon capture system 100 includes components for a CO₂-TSA processes with a semi-closed cycle. The components may be interconnected by a plurality of manifolds that may be configured to carry one or more fluids (e.g., liquids, gases, or gas-liquid mixtures).

The carbon capture system 100 may include an O₂ source 102 (e.g., an O₂ plant) that provides O₂, an air inlet and filter box 104 that provides air, an SCC path 106 that is used to provide a portion of cooled exhaust from an exhaust return path 108, an intake buffer tank 110, and an engine 112. As is the case with any combustion engine, fuel is combusted, and that combustion requires an oxidizer, which is generally air. The engine 112 (e.g., a turbine engine, piston engine) may draw in a working fluid 114 from the intake buffer tank 110. In some implementations, the engine 112 may be another type of exhaust source. The working fluid 114 used as an artificial atmosphere may be a mixture of air, oxygen, and cooled exhaust. A mixed concentration of oxygen in the intake buffer tank is a variable, but generally falls in the range of 12-22% O₂. The engine 112 combusts the fuel in the artificial atmosphere to produce a hot exhaust (e.g., a hot flue gas). The hot exhaust may flow through optional catalysts and supplemental combustion (block 116) to an exhaust heat exchanger (e.g., CO₂ heat exchanger (CO₂ HX) 118). The exhaust heat exchanger partially cools the hot exhaust (e.g., to about 400° F.). The partially cooled exhaust is then mixed with colder water by a spray mixer 120, which quenches the partially cooled exhaust down to about 100° F. As a result, most of the water from combustion products in the exhaust condenses, and the condensed water is removed in a gas-liquid separator 122 (e.g., a direct contact cooler (DCC)). The condensed water accumulates in a water storage tank 124 unless the condensed water is otherwise used or disposed of. For example, the condensed water may be used as make-up water in a cooling tower, eliminating or reducing a problem of water disposal.

The cooled exhaust (e.g., cold exhaust), now depleted of most of the water, returns to the intake buffer tank 110 via the SCC path 106 or to a TSA screw/blower 126 (fan) via a TSA path 128. The SCC path 106 is part of an SCC exhaust loop that starts at the intake buffer tank 110, proceeds through the gas-liquid separator 122 to the exhaust return path 108, and returns back through the SCC path to the intake buffer tank 110. The SCC is used to increase CO₂ concentration for an adsorption bed (e.g., for capture vessels TS3, TS4, and TS5) via exhaust recirculation.

A flowrate at the TSA screw/blower 126, which may be a variable speed drive or may include other methods of flow regulation, indirectly sets a level of exhaust recirculation, since an engine flowrate is essentially fixed. Thus, CO₂ that is not removed by the carbon capture system 100 may be recirculated, and a balance of the artificial atmosphere at the engine will be made up by air and/or oxygen.

Downstream of the TSA screw/blower 126 is a network of interconnected components that are responsible for performing the carbon capture via a CO₂-TSA process. Immediately downstream of the TSA screw/blower 126 is a heat exchanger/chiller 130, typically cooling the cold exhaust to 35-50° F., which will cause more water present in the cold exhaust to condense, reducing a load on molecular sieves that follow. A tank 131 may be connected immediately downstream from the heat exchanger/chiller 130 to separate the water from the cold exhaust.

Valves T1In, T2In, T1X, T2X, T1D, T2D, T1C, T2C, T1H, T2H, T3In, T4In, T5In, T3D, T4D, T5D, T3X, T4X, T5X, T3T, T4T, T5T, T3C, T4C, T5C, T3H, T4H, T5H, and BPR are used to control a flow of one or more fluids throughout the carbon capture system 100. An open state and a closed state of each of the valves may be controlled by a controller (not illustrated) according to one or more process stages of the CO₂-TSA process. For example, three capture vessels TS3, TS4, or TS5 may be arranged in parallel, and the valves may be controlled such that a process stage at each one of the three capture vessels TS3, TS4, or TS5 (e.g., CO₂ capture vessels) is controlled based on a batch sequence of the CO₂-TSA process. For example, the valves may be controlled such that the capture vessel TS3 is in an adsorption stage (e.g., a capture stage), while the capture vessel TS4 is in a cooling stage and the capture vessel TS4 is a regeneration stage. The valves may further be controlled such that the capture vessel TS4 in in an adsorption stage (e.g., a capture stage), while the capture vessel TSA5 is in a cooling stage and the capture vessel TSA3 is a regeneration stage. The valves may further be controlled such that the capture vessel TS5 in an adsorption stage (e.g., a capture stage), while the capture vessel TSA3 is in a cooling stage and the capture vessel TS4 is a regeneration stage. The batch sequence may then be repeated.

In some implementations, the capture vessels TS3, TS4, or TS5 may be referred to as “beds.” Each capture vessel TS3, TS4, and TS5 may include media (e.g., capture media) that is configured to capture or adsorb CO₂. In some cases, the media may also adsorb water.

A first step in the CO₂-TSA process is a water dehydration process carried out by a blend of alumina and a 3 A mole sieve in adsorbent vessels TSA1 and TSA2. The water dehydration process is a batch type process. Thus, when one adsorbent vessel TSA1 or TSA2 is adsorbing water, the other adsorbent vessel TSA1 or TSA2 is off-line, either being heated (e.g., for regeneration) or being cooled. Adsorbent vessels TSA1 and TSA2 may be referred to as capture vessels, which are arranged in the carbon capture system 100 for capturing water molecules in the cold exhaust. Valves TlIn and T2In control which adsorbent vessel TSA1 or TSA2 is receiving the cold exhaust from the heat exchanger/chiller 130. For description purposes, assuming adsorbent vessel TSA1 is dehydrating, then valve TlIn is open, and the cold exhaust flows through the adsorbent vessel TSA1 and out valve TID, through another cooler P2T, to one of the capture vessels TS3, TS4, or TS5 for carbon capture. At an adsorption inlet 132 of the capture vessels TS3, TS4, and TS5, the cold exhaust has essentially zero water, and is typically composed of 3-11% CO₂, 0-15% O₂, and a balance inert mixture (e.g., nitrogen, with a little argon). By adsorbing water molecules, adsorbent vessels TSA1 and TSA2 convert a wet gas into a dry gas (or a drier gas) that may be substantially depleted of water molecules. The adsorbent vessels TSA1 and TSA2 may be cycled through adsorption (e.g., a capture stage), regeneration (e.g., a regeneration stage), and cooling (e.g., a cooling stage). During adsorption, water molecules are captured by the capture media. During regeneration, the capture media may be heated to desorb and release the water molecules from the capture media as a water vapor stream. During cooling, the capture media may be cooled in order to prepare the capture media for the next adsorption stage, where cooling increases a capture efficiency of the capture media.

Assuming the capture vessel TS3 is at this point adsorbing CO₂, valve T3In will be open, with valves T4In and T5In closed. The exhaust gas, now depleted of CO₂ via the capture vessel TS3 and water via one of the adsorbent vessels TSA1 and TSA2, flows out of the capture vessel TS3 via valve T3T, which is open, while valves T4T and T5T are closed. The exhaust gas flowing out of the capture vessel TS3 is a relatively warm dry gas having a temperature around 80-160° F., and is composed mostly of N₂ gas, but may include other constituents. The exhaust gas flowing out of the capture vessel TS3 flows out of the capture vessel TS3 and through the valve T3T and may be manifolded to several locations. For simplicity, this relatively warm dry gas that flows out of the capture vessel performing CO₂ adsorption (e.g., capture vessel TS3) may be referred to as a dry N₂ gas or a (dry) depleted flue gas that may be substantially depleted of CO₂.

If all downstream valves are closed, or if a backpressure for some reason is too high, any excess depleted flue gas will be discharged to atmosphere via a CO₂ TSA vent, controlled by a back pressure regulator of the valve BPR. Generally, the backpressure is lower than a setpoint of the back pressure regulator and the valve BPR remains closed.

A portion of the depleted flue gas may be used to heat either adsorbent vessel TSA1 or TSA2 (e.g., whichever adsorbent vessel is not adsorbing water, in this example adsorbent vessel TSA2), or to cool TSA2, depending on a cycle time. During a heating process of one of the adsorbent vessels TSA1 or TSA2, the depleted flue gas may be directed through an N₂ heater 134 (e.g., a heat exchanger) by opening one of the valves TIH or T2H and closing both valves T1C and T2C. During a cooling process of one of the adsorbent vessels TSA1 or TSA2, the dry (warm) N₂ gas may be directed from the valve T3T to bypass the N₂ heater 134 by opening one of the valves T1C or T2C and closing both valves T1H and T2H.

For example, if a design point is 8 hours for water adsorption (dehydration) in the adsorbent vessel TSA1 and the adsorbent vessel TSA2, then the adsorbent vessel TSA1 would be set for adsorbing water for 8 hours, and, in parallel, the adsorbent vessel TSA2 would be first set for regeneration (heated) by opening valves T2H and T2X, using the heated dry N₂ from the N₂ heater 134, for about 4 hours, and then would be cooled, for about 4 hours, by opening valve T2C, while closing valve T2H with valve T2X still open. After 8 hours this process would reverse, with TSA2 taking over the adsorption (dehydration) duty, and with TSA1 being heated, then cooled, via combinations of valve actions at T1H, T1C, and T1X. The cycle time for water adsorption is typically several hours, generally between 3 and 12 hours.

After chilling and condensation, there is typically much more CO₂ in the exhaust than water in the exhaust, and the capacity for CO₂ per unit weight of mole sieve is lower than that of water. As a result, cycle times for CO₂ adsorption in the capture vessels TS3, TS4, and TS5 are measured in minutes, not hours. Assuming the capture vessel TS3 is adsorbing CO₂ (e.g., valves T3In and T3T are open), a portion of the depleted flue gas that exits the capture vessel TS3 via valve T3T, optionally further cooled via a heat exchanger/chiller 136, can pass through valve T4C to provide cooling to the capture vessel TS4, and can exit via valve T4X. It is noted that the volume of gas required for cooling may not be met fully by the flow rate coming from the capture vessel TS3, and methods to augment the flow via recirculation or mitigate the amount of flow needed are described below.

After the CO₂ adsorption cycle is complete (e.g., in capture vessel TS3), the captured CO₂ must be released during the regeneration stage. In a TSA process, releasing captured CO₂ is done mostly via heating. In the present disclosure, that heating is provided by a hot gas mixture, which is mostly hot CO₂ in this example delivered via valve T3H to the capture vessel TS3. The hot CO₂ is generally at 600-800° F. The hot CO₂ gas flows downward from a CO₂-turbocharger 138, through valve T3H, and through the media in the capture vessel TS3, which gradually heats the media, and drives off more CO₂. Warm CO₂ exits the capture vessel TS3 and flows via valve T3D to a cooler 140 (e.g., a heat exchanger), and a portion of the CO₂ gas splits off, flowing through a separator 142 (in theory unneeded, this being dry gas, it is really there to add volume to improve control), to a CO₂ screw compressor 144, to a chiller 145 (e.g., a heat exchanger), a CO₂ storage tank 146, and downstream to the rest of the CO₂ compression or use systems. The flowrate at the CO₂ screw compressor 144, also generally variable speed, indirectly sets a pressure in the capture vessel TS3 during a desorption process of the regeneration stage.

A desorption flowrate required is much higher than a raw exhaust flowrate on both a mass and volume basis. In addition, given the higher temperature, a pressure drop through the capture vessel would also be higher, up to 10 psi, vs. 1-2 psi for adsorption, resulting in high electrical loads. In the present disclosure, the CO₂ gas produced during the desorption process is recirculated to support these higher flowrates, and more importantly, a powering for a recirculation of the CO₂ gas is performed by the CO₂-turbocharger 138.

Heat used to power the CO₂-turbocharger 138, and to heat a capture vessel TS3, TS4, or TS5 during the regeneration stage, comes from the exhaust of the engine 112. After passing through valve T3D and the cooler 140, a portion of the CO₂ gas released from the relevant capture vessel TS3, TS4, or TS5 (e.g., capture vessel TS3 in this example,) enters a turbocharger compressor 148 of the CO₂-turbocharger 138 via manifold 149, boosted in pressure (e.g., to 15-25 psi), raising the temperature of the CO₂ gas to 300° F. or more. In other words, the manifold 149 connects capture vessel TS3, TS4, and TS5 to the turbocharger compressor 148 of the CO₂-turbocharger 138 to transport a CO₂ stream of CO₂ gas generated by a capture vessel set in the regeneration stage to the turbocharger compressor 148.

The heated CO₂ gas from the turbocharger compressor 148 then enters the CO₂ heat exchanger (CO₂ HX) 118, and is heated to near raw exhaust temperature, typically 800-900° F., by a heat exchange process that uses the exhaust from the engine 112 for further heating the heated CO₂ gas to produce hot CO₂ gas. This hot CO₂ gas is then expanded through an expander 150 (e.g., a decompressor) of the CO₂-turbocharger 138 (which causes the temperature of the hot CO₂ to drop due to less pressure). However, due to the super-heating process performed by the turbocharger compressor 148 and the CO₂ heat exchanger (CO₂ HX) 118, the CO₂ gas exiting the expander 150 still has a temperature equal to or greater than 600° F. that is sufficient for the regeneration process, and still at a pressure high enough to support a flow through the capture vessel TS3, TS4, or TS5 that is performing the regeneration (e.g., capture vessel TS3 in this example). For example, a pressure increase on a compressor side of the CO₂-turbocharger 138 significantly exceeds a pressure decrease on an expander side of the CO₂-turbocharger 138, such that a pressure of the CO₂ gas exiting the expander 150 toward the capture vessel TS3, TS4, or TS5 is high enough to support the flow of the CO₂ gas through the capture vessel TS3, TS4, or TS5 that is performing the regeneration. The expander 150 may be respectively coupled to the capture vessels TS3, TS4, TS5 via manifolds 152, 154, and 156 to provide a heated CO₂ gas to a capture vessel that is set in the regeneration stage. At an end of the regeneration process, virtually no CO₂, and almost no water, remains in the capture vessel TS3, TS4, or TS5 that is performing the regeneration (e.g., the capture vessel TS3).

As a result of the regeneration process, the media (e.g., the mole sieve) of the capture vessel TS3, TS4, or TS5 is hot, typically with an average temperature of about 500° F., and must be cooled to prepare the capture vessel for a next CO₂ adsorption cycle. A cooling process for the capture vessel TS3 is accomplished by opening valves T3C and T3X, while closing valves T3In, T3T, T3H, and T3D. In other words, the dry (warm) N₂ gas that exits the capture vessel set in the adsorbing stage (e.g., capture vessel TS5 for cooling of capture vessel TS3) is directed into the capture vessel TS3 for cooling the media of the capture vessel TS3.

The cooling process need not return the media temperature fully to ambient temperature. Any temperature under 100° C. (212° F.) will provide some capacity for initial adsorption of CO₂, with temperatures near or below 50° C. (122° F.) being preferred. The cooling process may continue in parallel with the adsorption process to some extent since a raw exhaust stream from cooler P2T (e.g., a heat exchanger) is provided at nominally 10° C. (50° F.).

In addition, each of the capture vessels TS3, TS4, or TS5 and/or the adsorbent vessels TSA1 and TSA2 may include one or more coils distributed internally such that the one or more coils are thermally coupled to the capture media of a capture vessel or an adsorbent vessel. The one or more coils may carry one or more thermal fluids for regulating a temperature of the capture media. The one or more thermal fluids may include a heating fluid configured to increase the temperature of the capture media during a regeneration stage of the capture media, and a cooling fluid configured to decrease the temperature of the capture media a during at least one of an adsorption stage of the capture media or a cooling stage of the capture media. In some implementations, the heating fluid and the cooling fluid may be a same thermal fluid, having been heated by a heater or cooled by a chiller for heating or cooling, respectively.

The carbon capture system 100 may include a temperature regulation system 158 that provides and regulates a flow of one or more thermal fluids to the coils of the capture vessels TS3, TS4, or TS5 and/or the adsorbent vessels TSA1 and TSA2. The temperature regulation system 158 may regulate the flow of one or more thermal fluids based on a process stage (e.g., adsorption, regeneration, or cooling) of each vessel such that heating of the capture media of a particular vessel or cooling of the capture media of a particular vessel is performed according to the process stage of that particular vessel.

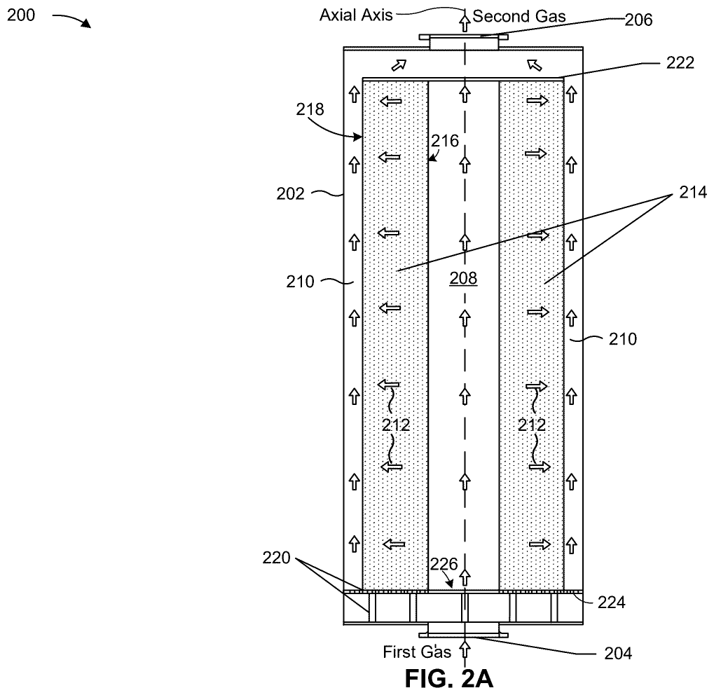

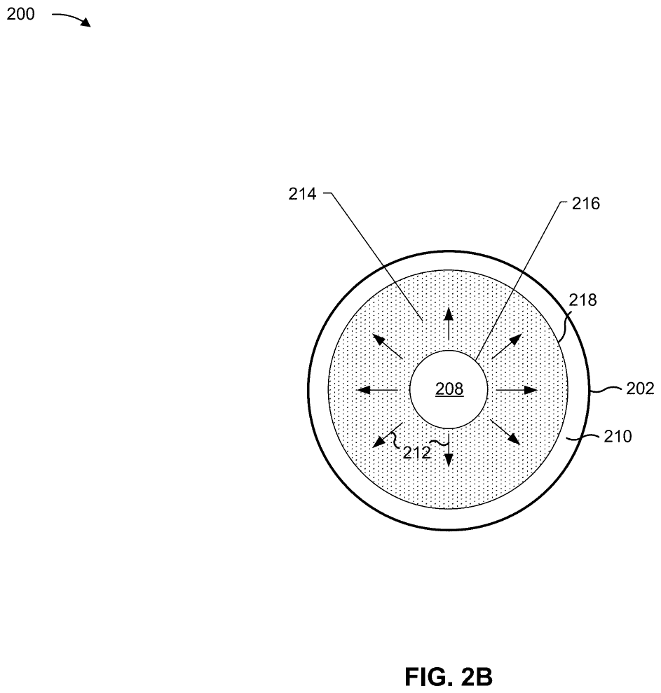

FIG. 2A illustrates an axial cross-section of a capture vessel 200 according to one or more implementations. FIG. 2B illustrates a radial cross-section of the capture vessel 200 shown in FIG. 2A. The capture vessel 200 may be one of the capture vessels TS3, TS4, or TS5, or one of the adsorbent vessels TSA1 or TSA2. In some implementations, the capture vessel 200 may be a cylindrical capture vessel with a radial dimension and a radial flow design. Thus, the capture vessel 200 may be a radial flow vessel in which gas flows radially through capture media.

The capture vessel 200 may include an outer vessel wall 202 that defines an interior volume of the capture vessel 200, an inlet flange 204 arranged at the outer vessel wall 202 and configured to receive a first gas and provide the first gas to the interior volume, and an outlet flange 206 arranged at the outer vessel wall 202 and configured to receive a second gas from the interior volume and output the second gas from the capture vessel 200. The outer vessel wall 202 may have a cylindrical shape.

The capture vessel 200 may further include an ingress flow channel 208 coupled to the inlet flange 204 to receive the first gas. The ingress flow channel 208 may extend, partially through the interior volume, parallel to an axial axis of the capture vessel 200.

The capture vessel 200 may further include a first egress flow channel 210 coupled to the outlet flange 206 to provide at least a first portion of the second gas to the outlet flange 206. The first egress flow channel 210 may extend, partially through the interior volume, parallel to the axial axis of the capture vessel 200. The first egress flow channel 210 may have a cylindrical shape.

The capture vessel 200 may further include one or more first radial flow channels 212 that extend radially between the ingress flow channel 208 and the first egress flow channel 210.

The capture vessel 200 may further include first capture media 214 arranged in the one or more first radial flow channels 212 and configured to convert at least a first portion of the first gas into the first portion of the second gas. The first capture media 214 may form a cylindrical media bed that is arranged radially between the ingress flow channel 208 and the first egress flow channel 210. The one or more first radial flow channels 212 may be configured to receive the first portion of the first gas from the ingress flow channel 208, such that the first portion of the first gas interacts with the first capture media 214 to produce the first portion of the second gas, and provide the first portion of the second gas to the first egress flow channel 210. Perforated plates 216 and 218 may be used to hold the first capture media 214 within an area of the interior volume provided for the one or more first radial flow channels 212, while permitting gas to flow between the ingress flow channel 208 and the first egress flow channel 210.

In some implementations, the capture vessel 200 may have a single-flow design such that all of the first gas flows through the cylindrical media bed from the ingress flow channel 208 to the first egress flow channel 210. As a result, all of the second gas is directed from the one or more first radial flow channels 212 to the first egress flow channel 210 and exits the outlet flange 206 from the first egress flow channel 210.

In some implementations, the ingress flow channel 208 may be a center manifold that extends along the axial axis and provides the ingress flow channel 208. The first egress flow channel 210 may be an outer cavity arranged between the first capture media 214 and the outer vessel wall 202 in a radial direction. The first egress flow channel 210 may have a cylindrical ring shape. Thus, the outer cavity that forms the first egress flow channel 210 may encircle the first capture media 214 to provide the first egress flow channel 210. In addition, the first capture media 214 (e.g., the cylindrical media bed) may encircle the center manifold that provides the ingress flow channel 208.

The capture vessel 200 may include a media support module 220 with internal media supports that provide structural support to the first capture media 214 (e.g., the cylindrical media bed). The first gas may pass through an inlet header area defined by the media support module 220 as the first gas flows from the inlet flange 204 to the ingress flow channel 208.

The capture vessel 200 may include one or more flow separators configured to separate the ingress flow channel 208 and the first egress flow channel 210 such that the first portion of the first gas (e.g., all of the first gas) is forced to flow radially through the one or more first radial flow channels 212. For example, the capture vessel 200 may include a first flow separator 222 arranged at a distal end (e.g., an output end) of the capture vessel 200 such that the first gas flowing in the ingress flow channel 208 is forced to flow radially outward through the one or more first radial flow channels 212 to the first egress flow channel 210. The center manifold may be capped by the first flow separator 222. In addition, the capture vessel 200 may include a second flow separator 224 arranged at a proximal end (e.g., an input end) of the capture vessel 200 such that the second gas is forced to flow toward the outlet flange 206. The second gas may flow through an outlet header area arranged between the first egress flow channel 210 and the outlet flange 206. The second flow separator 224 may prevent the second gas from flowing back toward the ingress flow channel 208 and/or the inlet flange 204. The second flow separator 224 may define an opening 226 that allows the first gas to flow from the inlet flange 204 to the ingress flow channel 208. Accordingly, the first gas and the second gas flow in a same axial direction.

Flow is assured to travel radially through the capture media 214 by utilizing a series of perforated plates and mesh screens, with mechanical supports as needed, to evenly distribute the flow axially across the interior volume. Mesh screens may be employed to provide a standoff between the perforated plate hole and the mole sieve media, preventing plugging.

In some implementations, the capture vessel 200 may be implemented as one of the capture vessels TS3, TS4, or TS5. Thus, the first gas may be an exhaust gas that contains CO₂, and the second gas may be a depleted flue gas. The first capture media 214 may be configured to adsorb CO₂ from the exhaust gas during a CO₂ capture stage to produce the depleted flue gas that exits the capture vessel 200.

In some implementations, the capture vessel 200 may be implemented as one of the adsorbent vessels TSA1 or TSA2. Thus, the first gas may be a wet gas, and the second gas may be a dry gas. The first capture media 214 may be configured to adsorb water molecules in the wet gas to produce the dry gas that exits the capture vessel 200.

A geometry of the capture vessel 200 may reduce a total pressure drop with the CO₂-TSA system to less than an inherent engine backpressure capability of the engine, and in the cases where this occurs, one or more draft fans can be eliminated or reduced in size. For example, a single-flow radial design of the capture vessel 200 enhances the hydraulic performance significantly through reduced pressure drop by increasing the cross-sectional flow area of the gas. For a given media mass, increasing the vessel height and decreasing the media thickness, defined as the difference between a first media interface and a second media interface (e.g., inner and outer diameter), reduce the vessel pressure drop. It should be also noted that decreasing the media thickness below a certain point reduces contact time between the gas and mole sieve beads which may reduce the capture percentage. Thus, there is a balance to be considered when reducing the media thickness, which reduces the vessel pressure drop but also reduces the contact time. Nevertheless, a radial flow design enables the media thickness to be reduced compared to, for example, some axial flow designs, and therefor enables reduced pressure drop. For example, for a cylindrical design with axial flow, increasing a vessel diameter above a certain point impacts a flow distribution, while increasing a height of media in the vessel leads to higher pressure drop, increasing the parasitic load on the draft fans, which may require additional draft fans or larger draft fans to handle the increased parasitic load. Additional draft fans or larger draft fans increase cost and complexity of the system, and also increase energy consumption and reduce overall power efficiency of the system. Thus, reducing the pressure drop may reduce energy consumption and increase overall power efficiency of the system by, for example, eliminating one or more draft fans and/or reducing one or more draft fans in size.

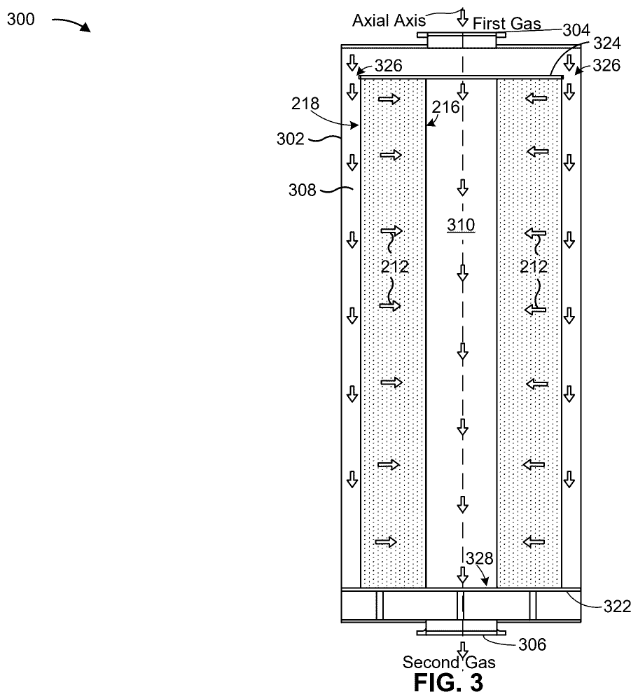

FIG. 3 illustrates an axial cross-section of a capture vessel 300 according to one or more implementations. The capture vessel 300 may be similar to the capture vessel 200 described in connection with FIGS. 2A and 2B, with an exception that first gas is forced to flow radially inward through the one or more first radial flow channels 212. The capture vessel 300 may be one of the capture vessels TS3, TS4, or TS5, or one of the adsorbent vessels TSA1 or TSA2. In some implementations, the capture vessel 300 may be a cylindrical capture vessel with a radial dimension.

The capture vessel 300 may include an outer vessel wall 302 that defines an interior volume of the capture vessel 300, an inlet flange 304 arranged at the outer vessel wall 302 and configured to receive a first gas and provide the first gas to the interior volume, and an outlet flange 306 arranged at the outer vessel wall 302 and configured to receive a second gas from the interior volume and output the second gas from the capture vessel 300. The outer vessel wall 302 may have a cylindrical shape.

The capture vessel 300 may further include an ingress flow channel 308 coupled to the inlet flange 304 to receive the first gas. The ingress flow channel 308 may extend, partially through the interior volume, parallel to an axial axis of the capture vessel 300. The ingress flow channel 308 may have a cylindrical shape.

The capture vessel 300 may further include a first egress flow channel 310 coupled to the outlet flange 306 to provide at least a first portion of the second gas to the outlet flange 306. The first egress flow channel 310 may extend, partially through the interior volume, parallel to the axial axis of the capture vessel 300.

The capture vessel 300 may further include one or more first radial flow channels 212 that extend radially between the ingress flow channel 308 and the first egress flow channel 310.

The capture vessel 300 may further include first capture media 214 arranged in the one or more first radial flow channels 212 and configured to convert at least a first portion of the first gas into the first portion of the second gas. The first capture media 214 may form a cylindrical media bed that is arranged radially between the ingress flow channel 308 and the first egress flow channel 310. The one or more first radial flow channels 212 may be configured to receive the first portion of the first gas from the ingress flow channel 308, such that the first portion of the first gas interacts with the first capture media 214 to produce the first portion of the second gas, and provide the first portion of the second gas to the first egress flow channel 310. Perforated plates 216 and 218 may be used to hold the first capture media 214 within an area of the interior volume provided for the one or more first radial flow channels 212, while permitting gas to flow between the ingress flow channel 308 and the first egress flow channel 310.

In some implementations, the capture vessel 300 may have a single-flow design such that all of the first gas flows through the cylindrical media bed from the ingress flow channel 308 to the first egress flow channel 310. As a result, all of the second gas is directed from the one or more first radial flow channels 212 to the first egress flow channel 310 and exits the outlet flange 306 from the first egress flow channel 310.

In some implementations, the first egress flow channel 310 may be a center manifold that extends along the axial axis and provides the first egress flow channel 310. The ingress flow channel 308 may be an outer cavity arranged between the first capture media 214 and the outer vessel wall 302 in a radial direction. Thus, the outer cavity that forms the ingress flow channel 308 may encircle the first capture media 214 to provide the ingress flow channel 308. In addition, the first capture media 214 (e.g., the cylindrical media bed) may encircle the center manifold that provides the first egress flow channel 310.

The capture vessel 300 may include one or more flow separators configured to separate the ingress flow channel 308 and the first egress flow channel 310 such that the first portion of the first gas (e.g., all of the first gas) is forced to flow radially through the one or more first radial flow channels 212. For example, the capture vessel 300 may include a first flow separator 322 arranged at a distal end (e.g., an output end) of the capture vessel 300 such that the first gas flowing in the ingress flow channel 308 is forced to flow radially inward through the one or more first radial flow channels 212 to the first egress flow channel 310. In addition, the capture vessel 300 may include a second flow separator 324 arranged at a proximal end (e.g., an input end) of the capture vessel 300 such that the second gas is forced to flow toward the outlet flange 306. The second flow separator 324 may prevent the second gas from flowing back toward the ingress flow channel 308 and/or the inlet flange 304. The second flow separator 324 may define an opening 326 that allows the first gas to flow from the inlet flange 304 to the ingress flow channel 308. The first flow separator 322 may define an opening 328 that allows the second gas to flow from the first egress flow channel 310 to the outlet flange 306.

In applications in which exhaust is captured from reciprocating gas engines, a geometry of the capture vessel 300 may reduce a total pressure drop with the CO₂-TSA system to less than an inherent engine backpressure capability of the engine, and in the cases where this occurs, one or more draft fans can be eliminated or reduced in size.

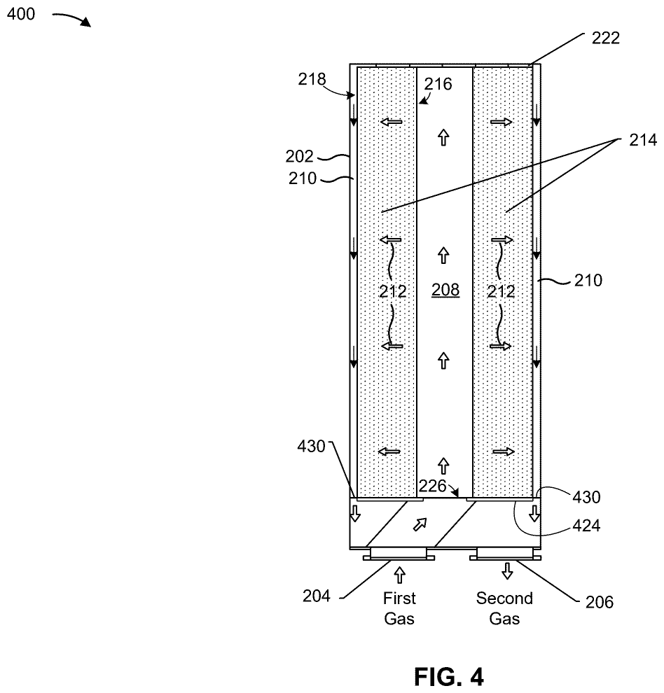

FIG. 4 illustrates an axial cross-section of a capture vessel 400 according to one or more implementations. The capture vessel 400 may be similar to the capture vessel 200 described in connection with FIGS. 2A and 2B, with an exception that the inlet flange 204 and the outlet flange 206 are arranged on a same side of the capture vessel 400. The capture vessel 400 may be one of the capture vessels TS3, TS4, or TS5, or one of the adsorbent vessels TSA1 or TSA2. In some implementations, the capture vessel 400 may be a cylindrical capture vessel with a radial dimension.

The first flow separator 222 arranged at a distal end of the capture vessel 400 may force the first gas flowing in the ingress flow channel 208 to flow radially outward through the one or more first radial flow channels 212 to the first egress flow channel 210. A second flow separator 424 arranged at a proximal end of the capture vessel 400 may enable the first gas to flow from the inlet flange 204 into the ingress flow channel 208 and may enable the second gas to flow out of the first egress flow channel 210 to the outlet flange 206. The second flow separator 424 may separate the ingress flow channel 208 and the first egress flow channel 210. The second flow separator 424 may define an opening 226 that allows the first gas to flow from the inlet flange 204 to the ingress flow channel 208. Additionally, the second flow separator 424 may define an opening 430 that allows the second gas to flow from the first egress flow channel 210 to the outlet flange 206. Accordingly, the first gas and the second gas flow in opposite axial directions.

An advantage of arranging the inlet flange 204 and the outlet flange 206 on the same side of the capture vessel 400 is a capability of scaling up for higher feed flowrates with increasing height and media load in the media bed. Arranging the inlet flange 204 and the outlet flange 206 on the same side of the capture vessel 400 may simplify construction and valve maintenance. In applications in which exhaust is captured from reciprocating gas engines, a geometry of the capture vessel 400 may reduce a total pressure drop with the CO₂-TSA system to less than an inherent engine backpressure capability of the engine, and in the cases where this occurs, one or more draft fans can be eliminated or reduced in size.

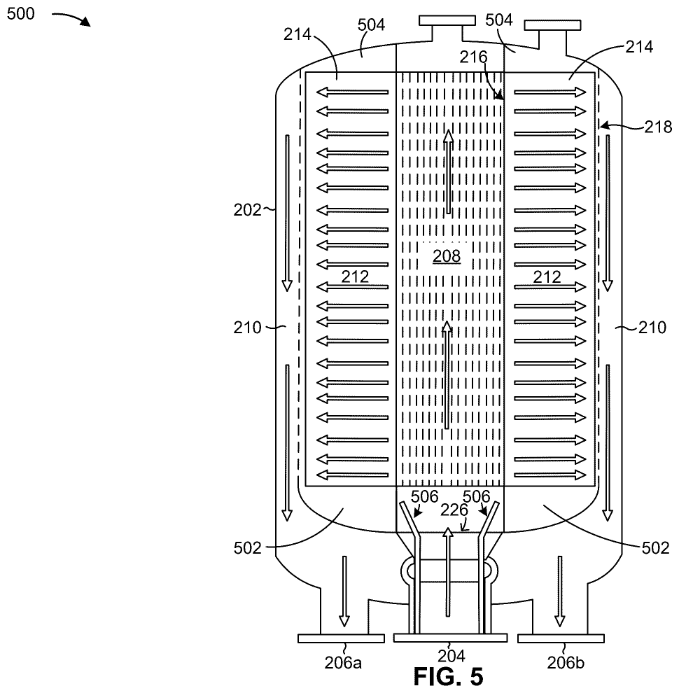

FIG. 5 illustrates an axial cross-section of a capture vessel 500 according to one or more implementations. The capture vessel 500 may share similar aspects with the capture vessel 400 described in connection with FIG. 4. The capture vessel 500 may include two outlet flanges 206a and 206b arranged at a same side of the capture vessel 500 as the inlet flange 204.

The capture vessel 500 may include a first temperature insulation layer 502 arranged at a first axial end of the first capture media 214 to insulate the first capture media 214. For example, the first temperature insulation layer 502 may be insulation material or capture media that is located outside of any flow channel (e.g., in a location where no gas flow occurs). In some implementations, the first temperature insulation layer 502 may be inert media.

The capture vessel 500 may include a second temperature insulation layer 504 arranged at a second axial end of the first capture media 214 to insulate the first capture media 214. For example, the second temperature insulation layer 504 may be insulation material or capture media that is located outside of any flow channel (e.g., in a location where no gas flow occurs). In some implementations, the second temperature insulation layer 504 may be inert media.

The first temperature insulation layer 502 and/or the second temperature insulation layer 504 may isolate the first capture media 214 from the inlet and the outlet header areas, and may improve a thermal capacity of the capture vessel 500.

The capture vessel 500 may include internal temperature insulation 506 that may insulate the ingress flow channel 208 from the first egress flow channel 210, and vice versa.

Additional insulation, either internal or external to the capture vessel 500 may also be provided.

An alternative arrangement may have the gas entering on the outer space between the media bed and the outer vessel wall 202, travelling radially through the capture media 214, and exiting through a center space, similar to the capture vessel 300 described in connection with FIG. 3. Any combination of flow direction from in-to-out or out-to-in could be used to for each of the three main stages (e.g., adsorption, regeneration, and cooling) to improve process performance.

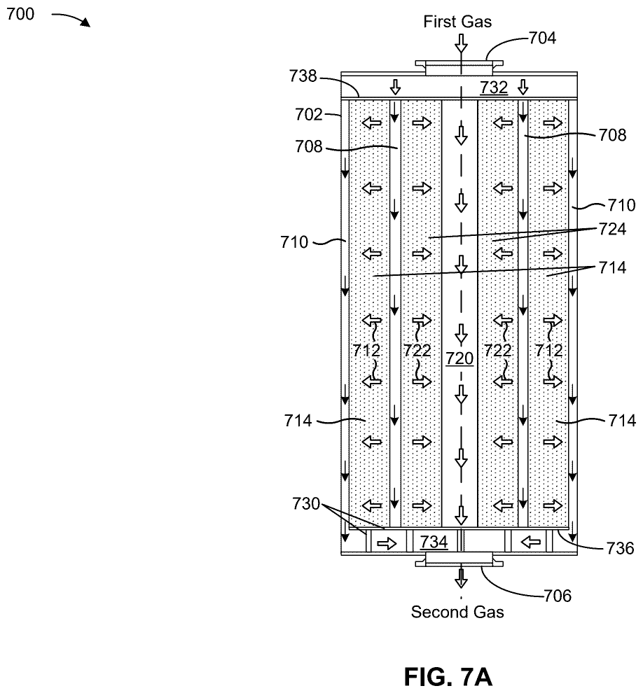

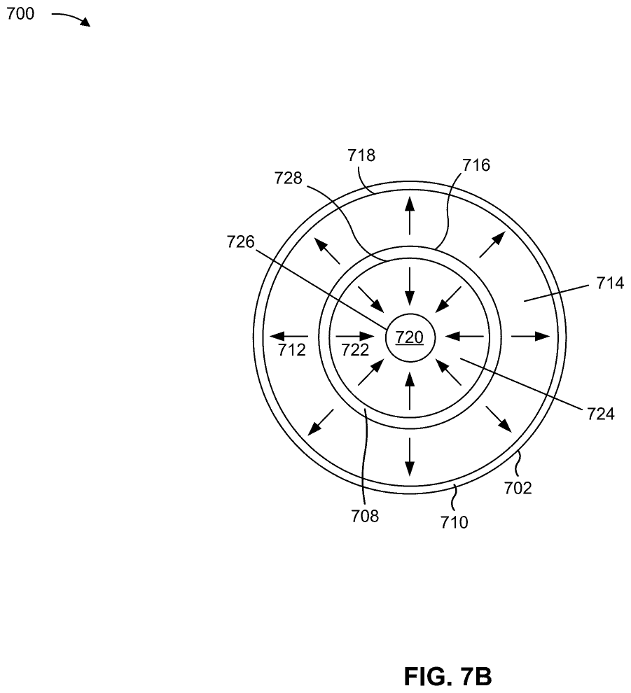

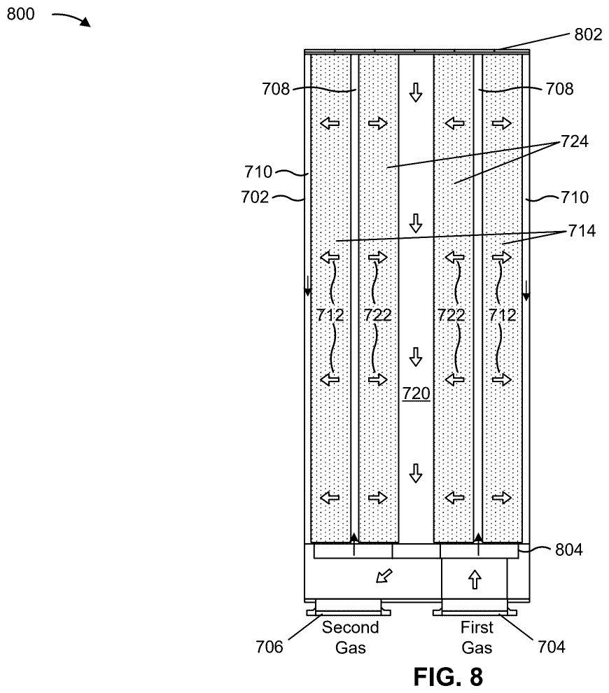

The same concepts are true for double-flow cylindrical radial designs as shown in FIGS. 7A, 7B, and 8, with the additional flow split internal to the vessel. The double-flow cylindrical radial design further improves the hydraulic performance, through reduced pressure drop, by doubling the cross-sectional flow area of the gas. All configurations help the pressure drop significantly as the cross-sectional area for the feed gas increases with increasing the height of the vessel.

A geometry of the capture vessel 500 may reduce a total pressure drop with the CO₂-TSA system to less than an inherent engine backpressure capability of the engine, and in the cases where this occurs, one or more draft fans can be eliminated or reduced in size.

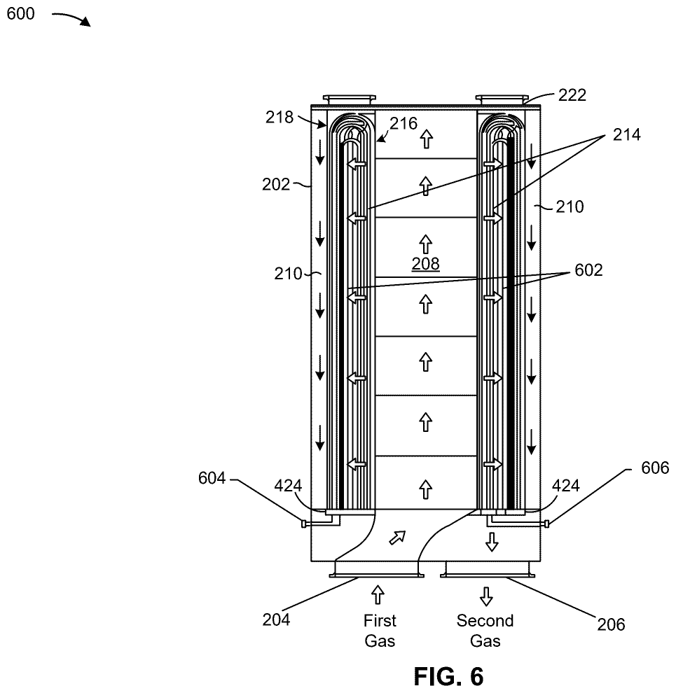

FIG. 6 illustrates an axial cross-section of a capture vessel 600 according to one or more implementations. The capture vessel 600 may share similar aspects with the capture vessel 400 described in connection with FIG. 4. In addition, the capture vessel 600 may include one or more coils 602 distributed within the interior volume and thermally coupled to the capture media 214. For example, the one or more coils 602 may be distributed within the one or more first radial flow channels 212 and thermally coupled to the first capture media 214. The one or more coils 602 may carry one or more thermal fluids for regulating a temperature of the first capture media 214. For example, the one or more thermal fluids may include a heating fluid configured to increase the temperature of the first capture media 214 during a regeneration stage of the first capture media 214, and/or a cooling fluid configured to decrease the temperature of the first capture media 214 during at least one of an adsorption stage of the capture media 214 or a cooling stage of the first capture media 214.

The capture vessel 600 may include a fluid inlet 604 arranged at the outer vessel wall 202 and configured to receive the one or more thermal fluids and provide the one or more thermal fluids to the one or more coils 602. The capture vessel 600 may include a fluid outlet 606 arranged at the outer vessel wall 202 and configured to output the one or more thermal fluids, having been circulated in the one or more coils 602, from the capture vessel 600. The fluid inlet 604 and the fluid outlet 606 may be coupled to the temperature regulation system 158 described in FIG. 1B. The temperature regulation system 158 may provide and regulate a flow of one or more thermal fluids to the one or more coils 602. A distributed system of coils, similar to the one or more coils 602, may be distributed within a media bed of any of the capture vessels described herein.

Due to the high heat of adsorption of CO₂ on mole sieves, a temperature rise experienced during the adsorption stage is significant and may negatively impact the adsorption capacity of CO₂ on mole sieves. Coils embedded within the media bed may be used for cooling the first capture media 214 to increase a carbon capture percentage by increasing a capacity of the first capture media 214.

For the adsorption and cooling stages, water or other chilled fluids or refrigerants could be used as a cooling fluid. Use of a coil in the bottom (or outer) layer of the media bed (e.g., a final layer) could be utilized to cool the gas as the gas exits the adsorption bed for the purpose of cooling the depleted flue gas.

During the regeneration stage, heat may be applied to the first capture media 214 to release the captured CO₂. The required heat can be supplemented by utilizing the same coils used in the adsorption or cooling steps, or a separate set of coils with a different fluid may be used. By using coils during the regeneration stage, a CO₂ regeneration rate may be increased, reducing a regeneration time as well as a cycle time of the TSA process. As a result, a performance of a capture process may be enhanced.

Once source of thermal fluid that could be utilized for both cooling and heating purposes could be pressurized CO₂ in the form of liquid for cooling the media bed and in the form of gas to heat the media bed. Another alternative for the heating fluid may be a suitable high temperature thermal fluid. Another alternative for the heating fluid may be to utilize high temperature exhaust, either from a capture source or another source.

FIG. 7A illustrates an axial cross-section of a capture vessel 700 according to one or more implementations. FIG. 7B illustrates a radial cross-section of the capture vessel 700 shown in FIG. 7A. The capture vessel 700 may be one of the capture vessels TS3, TS4, or TS5, or one of the adsorbent vessels TSA1 or TSA2. In some implementations, the capture vessel 700 may be a cylindrical capture vessel with a radial dimension.

The capture vessel 700 may include an outer vessel wall 702 that defines an interior volume of the capture vessel 700, an inlet flange 704 arranged at the outer vessel wall 702 and configured to receive a first gas and provide the first gas to the interior volume, and an outlet flange 706 arranged at the outer vessel wall 702 and configured to receive a second gas from the interior volume and output the second gas from the capture vessel 700. The outer vessel wall 702 may have a cylindrical shape.

The capture vessel 700 may further include an ingress flow channel 708 coupled to the inlet flange 704 to receive the first gas. The ingress flow channel 708 may extend, partially through the interior volume, parallel to an axial axis of the capture vessel 700. The ingress flow channel 708 may have a cylindrical shape.

The capture vessel 700 may further include a first egress flow channel 710 coupled to the outlet flange 706 to provide a first portion of the second gas to the outlet flange 706. The first egress flow channel 710 may extend, partially through the interior volume, parallel to the axial axis of the capture vessel 700. The first egress flow channel 710 may have a cylindrical shape.

The capture vessel 200 may further include one or more first radial flow channels 712 that extend radially between the ingress flow channel 708 and the first egress flow channel 710.

The capture vessel 700 may further include first capture media 714 arranged in the one or more first radial flow channels 712 and configured to convert a first portion of the first gas into the first portion of the second gas. The first capture media 714 may form a first cylindrical media bed that is arranged radially between the ingress flow channel 708 and the first egress flow channel 710. The one or more first radial flow channels 712 may be configured to receive the first portion of the first gas from the ingress flow channel 708, such that the first portion of the first gas interacts with the first capture media 714 to produce the first portion of the second gas, and provide the first portion of the second gas to the first egress flow channel 710. Thus, the first gas may flow radially outward from the ingress flow channel 708 toward the first egress flow channel 710, being converted into the second gas as the first gas interacts with the first capture media 714.

Perforated plates 716 and 718 may be used to hold the first capture media 714 within an area of the interior volume provided for the one or more first radial flow channels 712, while permitting gas to flow between the ingress flow channel 708 and the first egress flow channel 710.

The capture vessel 700 may further include a second egress flow channel 720 coupled to the outlet flange 706 to provide a second portion of the second gas to the outlet flange 706. The second egress flow channel 720 may extend, partially through the interior volume, parallel to the axial axis of the capture vessel 700.

The capture vessel 700 may further include one or more second radial flow channels 722 that extend radially between the ingress flow channel 708 and the second egress flow channel 720.

The capture vessel 700 may further include second capture media 724 arranged in the one or more second radial flow channels 722 and configured to convert a second portion of the first gas into the second portion of the second gas. The second capture media 724 may form a second cylindrical media bed that is arranged radially between the ingress flow channel 708 and the second egress flow channel 720. The one or more second radial flow channels 722 may be configured to receive the second portion of the first gas from the ingress flow channel 708, such that the second portion of the first gas interacts with the second capture media 724 to produce the second portion of the second gas, and provide the second portion of the second gas to the second egress flow channel 720. Thus, the first gas may flow radially inward from the ingress flow channel 708 toward the second egress flow channel 720, being converted into the second gas as the first gas interacts with the second capture media 724.

Perforated plates 726 and 728 may be used to hold the second capture media 724 within an area of the interior volume provided for the one or more second radial flow channels 722, while permitting gas to flow between the ingress flow channel 708 and the second egress flow channel 720.

The capture vessel 700 may be a double-flow capture vessel that has two separate egress flow channels. The ingress flow channel 708 may be arranged radially between the first capture media 714 and the second capture media 724 (e.g., radially between the first egress flow channel 710 and the second egress flow channel 720). The second egress flow channel 720 may be a center manifold that extends along the axial axis and provides the second egress flow channel 720.

An inner cavity may encircle the second capture media 724 and may provide the ingress flow channel 708. Thus, the inner cavity (e.g., the ingress flow channel 708) may be arranged radially between the first capture media 714 and the second capture media 724.

An outer cavity may be arranged radially between the first capture media 714 and the outer vessel wall 702, and may provide the first egress flow channel 710. Thus, the outer cavity (e.g., the first egress flow channel 710) may encircle the first capture media 714, the first capture media 714 may encircle the inner cavity (e.g., the ingress flow channel 708), the inner cavity may encircle the second capture media 724, and the second capture media 724 may encircle the center manifold (e.g., the second egress flow channel 720).

The capture vessel 700 may include a media support module 730 with internal media supports that provide structural support to the first capture media 714 (e.g., the first cylindrical media bed) and the second capture media 724 (e.g., the second cylindrical media bed).

The first gas may pass through an inlet header area 732 as the first gas flows from the inlet flange 704 to the ingress flow channel 708. The second gas may pass through an outlet header area 734 as the second gas flows from the first egress flow channel 710 and the second egress flow channel 720 to the outlet flange 706.

The capture vessel 700 may include one or more flow separators configured to separate the ingress flow channel 708 from the first egress flow channel 710 and the second egress flow channel 720 such that the first portion of the first gas is forced to flow radially through the one or more first radial flow channels 712 and the second portion of the first gas is forced to flow radially through the one or more second radial flow channels 722. For example, the capture vessel 700 may include a first flow separator 736 arranged at a distal end (e.g., an output end) of the capture vessel 700 such that the first gas flowing in the ingress flow channel 708 is forced to flow radially through the first egress flow channel 710 and the second egress flow channel 720. The first flow separator 736 may include openings that allow the second gas to flow from the first egress flow channel 710 and the second egress flow channel 720 to the outlet flange 706 (e.g., through the outlet header area 734). In addition, the capture vessel 700 may include a second flow separator 738 arranged at a proximal end (e.g., an input end) of the capture vessel 700 such that the second gas forced to flow toward the outlet flange 706. The second flow separator 738 may include openings that allow the first gas to flow into the ingress flow channel 708 from the inlet flange 704 (e.g., through the inlet header area 732).

While not shown in FIG. 7, the capture vessel 700 may include one or more coils distributed within the first radial flow channels 712 and the second radial flow channels 722. The one or more coils may be thermally coupled to the first capture media 714 and the second capture media 724. The one or more coils may carry one or more thermal fluids for regulating a temperature of the first capture media 714 and the second capture media 724.

In addition, the capture vessel 700 may include one or more first temperature insulation layers arranged at first axial ends of the first capture media 714 and the second capture media 724 to insulate the first capture media 714 and the second capture media 724, as similarly described in connection with FIG. 5. The capture vessel 700 may include one or more second temperature insulation layers arranged at second axial ends of the first capture media 714 and the second capture media 724 to insulate the first capture media 714 and the second capture media 724, as similarly described in connection with FIG. 5.

In some implementations, the capture vessel 700 may be implemented as one of the capture vessels TS3, TS4, or TS5. Thus, the first gas may be an exhaust gas that contains CO₂, and the second gas may be a depleted flue gas. The first capture media 714 and the second capture media 724 may be configured to adsorb CO₂ from the exhaust gas during a CO₂ capture stage to produce the depleted flue gas that exits the capture vessel 700.

In some implementations, the capture vessel 700 may be implemented as one of the adsorbent vessels TSA1 or TSA2. Thus, the first gas may be a wet gas, and the second gas may be a dry gas. The first capture media 714 and the second capture media 724 may be configured to adsorb water molecules in the wet gas to produce the dry gas that exits the capture vessel 700.

The double-flow cylindrical radial design of the capture vessel 700 may further improve hydraulic performance, through reduced pressure drop, by doubling the cross-sectional flow area of the gas. A geometry of the capture vessel 700 may reduce a total pressure drop with the CO₂-TSA system to less than an inherent engine backpressure capability of the engine, and in the cases where this occurs, one or more draft fans can be eliminated or reduced in size. The double-flow cylindrical radial design may further improve a hydraulic performance, through reduced pressure drop, by doubling a cross-sectional flow area of the gas.

FIG. 8 illustrates an axial cross-section of a capture vessel 800 according to one or more implementations. The capture vessel 800 may be similar to the capture vessel 700 described in connection with FIGS. 7A and 7B, with an exception that the inlet flange 704 and the outlet flange 706 are arranged on a same side of the capture vessel 800. The capture vessel 800 may be one of the capture vessels TS3, TS4, or TS5, or one of the adsorbent vessels TSA1 or TSA2. In some implementations, the capture vessel 800 may be a cylindrical capture vessel with a radial dimension.

A first flow separator 802 arranged at a distal end of the capture vessel 800 may force the first gas flowing in the ingress flow channel 708 to flow radially through the one or more first radial flow channels 712 and the one or more second radial flow channels 722. The first flow separator 802 may also force the second gas to flow toward the outlet flange 706. A second flow separator 804 arranged at a proximal end of the capture vessel 800 may enable the first gas to flow from the inlet flange 704 into the ingress flow channel 708 and may enable the second gas to flow out of the first egress flow channel 710 and the second egress flow channel 720 to the outlet flange 706. Accordingly, the first gas and the second gas flow in opposite axial directions.

The double-flow cylindrical radial design of the capture vessel 800 may further improve hydraulic performance, through reduced pressure drop, by doubling the cross-sectional flow area of the gas. A geometry of the capture vessel 800 may reduce a total pressure drop with the CO₂-TSA system to less than an inherent engine backpressure capability of the engine, and in the cases where this occurs, one or more draft fans can be eliminated or reduced in size.

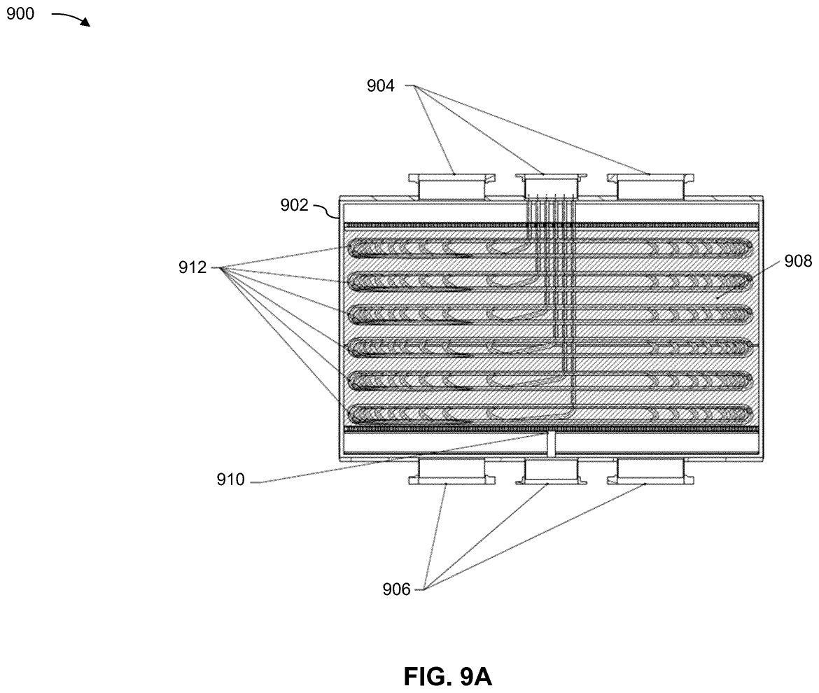

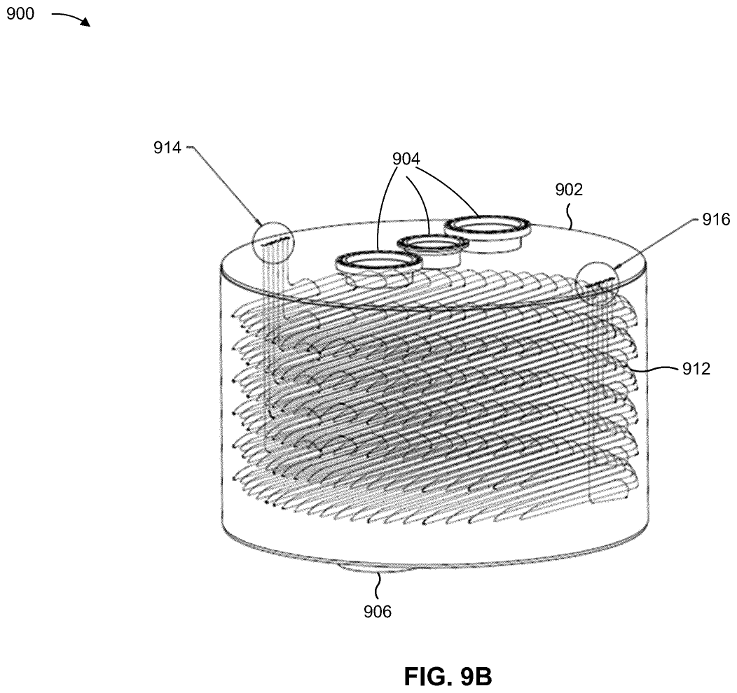

FIG. 9A illustrates an axial cross-section of a capture vessel 900 according to one or more implementations. FIG. 9B illustrates a perspective view of the capture vessel 900 shown in FIG. 9A. The capture vessel 900 may be an axial flow vessel in which gas flows axially through capture media.

The capture vessel 900 may include an outer vessel wall 902 that defines an interior volume of the capture vessel 900, one or more inlet flanges 904 arranged at a first axial side of the outer vessel wall 902 and configured to receive a first gas and provide the first gas to the interior volume, and one or more outlet flanges 906 arranged at the outer vessel wall 902 and configured to receive a second gas from the interior volume and output the second gas from the capture vessel 900. The outer vessel wall 902 may have a cylindrical shape or a box shape.

The capture vessel 900 may have a pancake or disc shape with a large diameter or large width. Thus, multiple inlet flanges 904 and multiple outlet flanges 906 may enable an improved gas flow through the capture vessel 900, while ensuring gas is distributed equally throughout the interior volume to maximize exposure of the gas to capture media.

In the interior volume of the capture vessel 900, the capture vessel 900 may include capture media 908 (e.g., a media bed), a media support structure 910 that supports the capture media 908, and one or more coils 912 distributed within the interior volume and thermally coupled to the capture media 908. The one or more coils 912 may carry one or more thermal fluids for regulating a temperature of the capture media 908. For example, the one or more thermal fluids may include a heating fluid configured to increase the temperature of the capture media 908 during a regeneration stage of the capture media 908, and a cooling fluid configured to decrease the temperature of the capture media 908 during at least one of an adsorption stage of the capture media 908 or a cooling stage of the capture media 908. The one or more coils 912 may be arranged in a sequence of layers that are layered on top of each other in an axial direction.

The capture vessel 900 may include one or more fluid inlets 914 arranged at the outer vessel wall 902 and configured to receive the one or more thermal fluids and provide the one or more thermal fluids to the one or more coils 912. The capture vessel 900 may include one or more fluid outlets 916 arranged at the outer vessel wall 902 and configured to output the one or more thermal fluids, having been circulated in the one or more coils 912, from the capture vessel 900. The fluid inlets 914 and the fluid outlets 916 may be coupled to the temperature regulation system 158 described in FIG. 1B. The temperature regulation system 158 may provide and regulate a flow of one or more thermal fluids to the one or more coils 912.

A geometry of the capture vessel 900 may reduce a total pressure drop with the CO₂-TSA system to less than an inherent engine backpressure capability of the engine, and in the cases where this occurs, one or more draft fans can be eliminated or reduced in size.

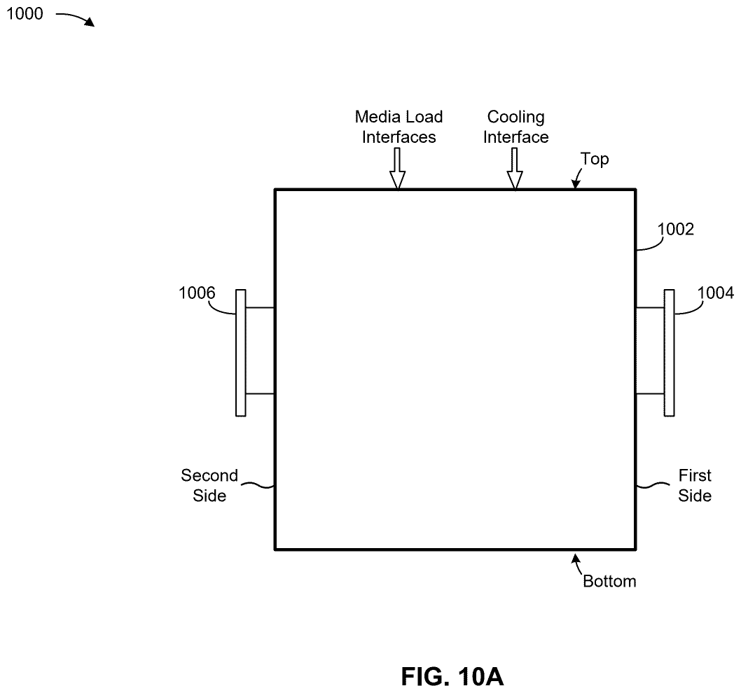

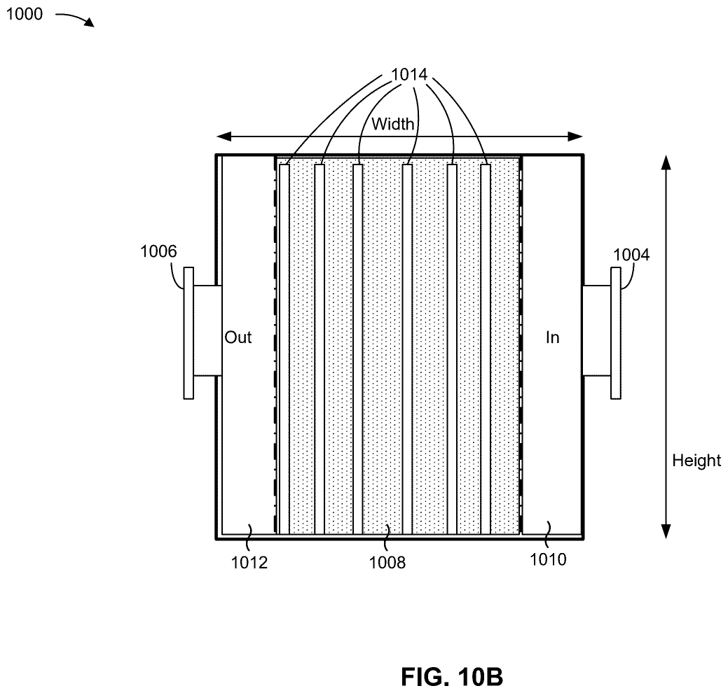

FIG. 10A illustrates a side view of a capture vessel 1000 according to one or more implementations. FIG. 10B illustrates a cross-section of the capture vessel 1000 shown in FIG. 10A. The capture vessel 1000 may be an axial flow vessel in which gas flows axially through capture media.

The capture vessel 1000 may include an outer vessel wall 1002 that defines an interior volume of the capture vessel 1000, an inlet flange 1004 arranged at the outer vessel wall 1002 and configured to receive a first gas and provide the first gas to the interior volume, and an outlet flange 1006 arranged at the outer vessel wall 1002 and configured to receive a second gas from the interior volume and output the second gas from the capture vessel 1000. The outer vessel wall 1002 may have a rectangular box shape. In addition, the inlet flange 1004 may be arranged at a first side, and the outlet flange 1006 may be arranged at a second side that is opposite to the first side. Media load interfaces and a cooling interface may be arranged at a top side of the capture vessel 1000.

In the interior volume of the capture vessel 1000, the capture vessel 1000 may include capture media 1008 (e.g., a media bed) arranged between an inlet header area 1010 and an outlet header area 1012. The capture vessel 1000 may also include one or more coils 1014 distributed within the interior volume and thermally coupled to the capture media 1008.

In designs in which the inlet flange 1004 the outlet flange 1006 are located on opposite sides of the outer vessel wall 1002, instead of at a top and bottom of the outer vessel wall 1002, an amount of support structure is reduced, since the capture vessel 1000 can be self-supported. In addition, installation and maintenance activities may also be facilitated by increasing access to the capture media 1008 through a top of the capture vessel 1000, without interfering with inlet and outlet manifolds.

Internal manifolding and perforated plate structures may be included to allow for larger gas flows and a reduced pressure drop penalty.

A geometry of the capture vessel 1000 may reduce a total pressure drop with the CO₂-TSA system to less than an inherent engine backpressure capability of the engine, and in the cases where this occurs, one or more draft fans can be eliminated or reduced in size.

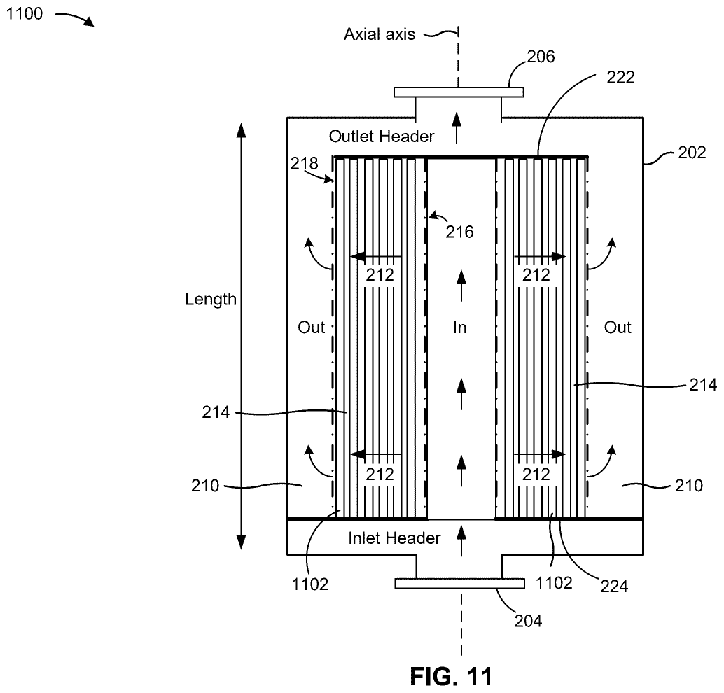

FIG. 11 illustrates an axial cross-section of a capture vessel 1100 according to one or more implementations. The capture vessel 1100 may be similar to the capture vessel 200 described in connection with FIGS. 2A and 2B, with an exception that the capture vessel 1100 has a rectangular box shape. Thus, the capture vessel 1100 may be a radial flow vessel in which gas flows radially (or perpendicular to an axial axis) through the capture media 214.

The capture vessel 1100 may also include one or more coils 1102 distributed within an interior volume of the capture vessel 1100 and thermally coupled to the capture media 214.

A geometry of the capture vessel 1100 may reduce a total pressure drop with the CO₂-TSA system to less than an inherent engine backpressure capability of the engine, and in the cases where this occurs, one or more draft fans can be eliminated or reduced in size.

### INDUSTRIAL APPLICABILITY

Advanced capture vessel designs disclosed herein may improve capture performance via enhanced utilization of a capture media and may reduce parasitic electrical loads of a carbon capture system through improved hydraulic performance requirements of the capture vessel. Each capture vessel configuration described herein may help reduce pressure drop significantly as a cross-sectional area for a feed gas increases with increasing a height of the capture vessel. In applications capturing exhaust from reciprocating gas engines, the capture vessel geometries described herein may reduce the total pressure drop with the CO₂-TSA system to less than an inherent engine backpressure capability of the engine such that one or more draft fans in the CO₂-TSA system can be eliminated or reduced in size.

In some implementations, a capture vessel geometry may decrease a vessel pressure drop and increase a utilization of the capture media. An energy cost associated with CO₂ capture can be significantly reduced by utilizing the advanced capture vessel designs described herein, which may significantly reduce the carbon capture system's pressure drop requirements and may increase the utilization of the capture media.

Some implementations provide design features for capture vessels to improve a capture performance and significantly reduce a parasitic electrical load of the carbon capture system associated with vessel hydraulic requirements. These design features include, but are not limited to: alternative vessel geometries and internal designs for improved hydraulic performance and/or internal coils for controlling or otherwise regulating capture bed temperature using a heat transfer fluid for either vessel cooling, vessel heating, or both vessel cooling and vessel heating, depending on a process stage.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A capture vessel, comprising:
an outer vessel wall that defines an interior volume of the capture vessel;
an inlet flange arranged at the outer vessel wall and configured to receive a first gas and provide the first gas to the interior volume;
an outlet flange arranged at the outer vessel wall and configured to receive a second gas from the interior volume and output the second gas from the capture vessel;
an ingress flow channel coupled to the inlet flange to receive the first gas, wherein the ingress flow channel extends, partially through the interior volume, parallel to an axial axis of the capture vessel;
a first egress flow channel coupled to the outlet flange to provide at least a first portion of the second gas to the outlet flange, wherein the first egress flow channel extends, partially through the interior volume, parallel to the axial axis of the capture vessel;
one or more first radial flow channels that extend radially between the ingress flow channel and the first egress flow channel; and
first capture media arranged in the one or more first radial flow channels and configured to convert at least a first portion of the first gas into the first portion of the second gas,
wherein the one or more first radial flow channels are configured to receive the first portion of the first gas from the ingress flow channel, such that the first portion of the first gas interacts with the first capture media to produce the first portion of the second gas, and provide the first portion of the second gas to the first egress flow channel.

2. The capture vessel of claim 1, wherein the first gas is an exhaust gas that contains CO₂,
wherein the second gas is a depleted flue gas, and
wherein the first capture media are configured to adsorb CO₂ from the exhaust gas during a CO₂ capture stage to produce the depleted flue gas that exits the capture vessel.

3. The capture vessel of claim 1, wherein the first gas is a wet gas,
wherein the second gas is a dry gas, and
wherein the first capture media are configured to adsorb water molecules in the wet gas to produce the dry gas that exits the capture vessel.

4. The capture vessel of claim 1, further comprising:
one or more flow separators configured to separate the ingress flow channel and the first egress flow channel such that the first portion of the first gas is forced to flow radially through the one or more first radial flow channels.

5. The capture vessel of claim 1, further comprising:
a center manifold that extends along the axial axis and provides the ingress flow channel; and
an outer cavity arranged between the first capture media and the outer vessel wall in a radial direction and having a cylindrical ring shape, wherein the outer cavity encircles the first capture media and provides the first egress flow channel, and
wherein the first capture media encircles the center manifold.

6. The capture vessel of claim 1, further comprising:
a center manifold that extends along the axial axis and provides the first egress flow channel; and
an outer cavity arranged between the first capture media and the outer vessel wall in a radial direction and having a cylindrical ring shape, wherein the outer cavity encircles the first capture media and provides the ingress flow channel, and
wherein the first capture media encircles the center manifold.

7. The capture vessel of claim 1, further comprising:
one or more coils distributed within the one or more first radial flow channels and thermally coupled to the first capture media,
wherein the one or more coils are configured to carry one or more thermal fluids for regulating a temperature of the first capture media.

8. The capture vessel of claim 7, wherein the one or more thermal fluids include a heating fluid configured to increase the temperature of the first capture media during a regeneration stage of the first capture media, and a cooling fluid configured to decrease the temperature of the first capture media during at least one of a CO₂ adsorption stage or a cooling stage of the first capture media.

9. The capture vessel of claim 1, further comprising:
a first temperature insulation layer arranged at a first axial end of the first capture media to insulate the first capture media; and
a second temperature insulation layer arranged at a second axial end of the first capture media to insulate the first capture media.

10. The capture vessel of claim 1, further comprising:
internal temperature insulation configured to insulate the ingress flow channel from the first egress flow channel, and vice versa.

11. The capture vessel of claim 1, further comprising:
a second egress flow channel coupled to the outlet flange to provide a second portion of the second gas to the outlet flange, wherein the second egress flow channel extends, partially through the interior volume, parallel to the axial axis of the capture vessel;
one or more second radial flow channels that extend radially between the ingress flow channel and the second egress flow channel; and
second capture media arranged in the one or more second radial flow channels and configured to convert a second portion of the first gas into the second portion of the second gas,
wherein the one or more second radial flow channels are configured to receive the second portion of the first gas from the ingress flow channel, such that the second portion of the first gas interacts with the second capture media to produce the second portion of the second gas, and provide the second portion of the second gas to the second egress flow channel.

12. The capture vessel of claim 11, further comprising:
one or more flow separators configured to separate the ingress flow channel from the first egress flow channel and the second egress flow channel such that the first portion of the first gas is forced to flow radially through the one or more first radial flow channels and the second portion of the first gas is forced to flow radially through the one or more second radial flow channels.

13. The capture vessel of claim 11, wherein the ingress flow channel is arranged radially between the first capture media and the second capture media.

14. The capture vessel of claim 11, wherein the ingress flow channel is arranged radially between the first egress flow channel and the second egress flow channel.

15. The capture vessel of claim 11, further comprising:
a center manifold that extends along the axial axis and provides the second egress flow channel;
an inner cavity arranged radially between the first capture media and the second capture media, wherein the inner cavity encircles the second capture media and provides the ingress flow channel; and
an outer cavity arranged radially between the first capture media and the outer vessel wall, wherein the outer cavity encircles the first capture media and provides the first egress flow channel.

16. The capture vessel of claim 15, wherein the outer cavity encircles the first capture media, the first capture media encircles the inner cavity, the inner cavity encircles the second capture media, and the second capture media encircles the center manifold.

17. The capture vessel of claim 11, further comprising:
one or more coils distributed within the first radial flow channels and the second radial flow channels, wherein the one or more coils are thermally coupled to the first capture media and the second capture media, wherein the one or more coils are configured to carry one or more thermal fluids for regulating a temperature of the first capture media and the second capture media.

18. The capture vessel of claim 17, wherein the one or more thermal fluids include a heating fluid configured to increase the temperature of the first capture media and the second capture media during a regeneration stage of the first capture media and the second capture media, and a cooling fluid configured to decrease the temperature of the first capture media and the second capture media during at least one of a CO₂ adsorption stage or a cooling stage of the first capture media and the second capture media.

19. The capture vessel of claim 11, further comprising:
one or more first temperature insulation layers arranged at first axial ends of the first capture media and the second capture media to insulate the first capture media and the second capture media; and
one or more second temperature insulation layers arranged at second axial ends of the first capture media and the second capture media to insulate the first capture media and the second capture media.

20. A capture vessel, the capture vessel comprising:
an outer vessel wall that defines an interior volume of the capture vessel;
an inlet flange arranged at the outer vessel wall and configured to receive a first gas and provide the first gas to the interior volume;
an outlet flange arranged at the outer vessel wall and configured to receive a second gas from the interior volume and output the second gas from the capture vessel;
capture media arranged within the interior volume of the capture vessel and to convert the first gas into the second gas by adsorption of one or more adsorbates; and
one or more coils distributed within the interior volume and thermally coupled to the capture media,
wherein the one or more coils are configured to carry one or more thermal fluids for regulating a temperature of the capture media, and
wherein the one or more thermal fluids include a heating fluid configured to increase the temperature of the capture media during a regeneration stage of the capture media, and a cooling fluid configured to decrease the temperature of the capture media during at least one of an adsorption stage of the capture media or a cooling stage of the capture media.
